(19) United States
(12) Patent Application Publication
(10) Pub. No.: US 2020/0395004 A1
(43) Pub. Date: Dec. 17, 2020

(54) Computer System, Model Generation Method, and Computer Readable Recording Medium

(71) Applicant: Hitachi, Ltd., Tokyo (JP)

(72) Inventors: Kenta YAMASAKI, Tokyo (JP); Isao TAZAWA, Tokyo (JP); Masaharu UKEDA, Tokyo (JP)

(21) Appl. No.: 16/829,562

(22) Filed: Mar. 25, 2020

(30) Foreign Application Priority Data
Jun. 13, 2019 (JP) 2019-110039

(51) Int. Cl. G10L 15/06; G06N 20/00; G06N 5/04

(52) U.S. Cl. CPC G10L 15/063; G06N 5/04; G06N 20/00

(57) ABSTRACT

A computer system includes: a model generation system configured to generate a model using learning data; and a model management system configured to record model generation data created in accordance with users who use a prediction process based on the model in association with the users, group the users according to a prescribed grouping condition, and supply the model generation system with learning data including model generation data created in accordance with users belonging to the group and cause the model generation system to generate an integrated model corresponding to the group.

### CROSS-REFERENCE TO RELATED APPLICATIONS

This application is based upon and claims the benefit of priority from Japanese Patent Application No. 2019-110039 filed in Japan Patent Office on Jun. 13, 2019, the contents of which are hereby incorporated by reference.

### BACKGROUND

The present invention relates to a technique for customizing a model, generated using learning data, for a user.

In recent years, developments have been made in speech recognition technology owing to progresses in machine learning, resulting in an increase in services and applications using such technology. Hereinafter, applications will be occasionally abbreviated as apps. Furthermore, services that provide an app utilizing such speech recognition technology as a cloud computing service have become popular.

In the field of speech recognition technology, methods that use an acoustic model for analyzing acoustic features of speech of a recognition target and a language model for analyzing linguistic features such as a sequence of words are well known. Hereinafter, references to a model include both an acoustic model and a language model.

In an app using speech recognition technology, a user using the app can individually customize a standard model provided by the app. For example, by adding words frequently used by a certain user to a model, it is expected that speech uttered by the user can be subsequently recognized with greater accuracy.

In a system disclosed in Japanese Translation of PCT Application No. 2017-515141 (PATENT LITERATURE 1), a list of a plurality of language modeling components that correspond to a plurality of domains is presented to a user in order to have the user select language modeling components to be used in customization. When the user selects language modeling components from the list, the system generates a language model customized based on a combination of the selected language modeling components and on hints.

PATENT LITERATURE 1: Japanese Translation of PCT Application No. 2017-515141

### SUMMARY

In the technique disclosed in Japanese Translation of PCT Application No. 2017-515141, a plurality of language modeling components are presented to a user in order to have the user select language modeling components to be used in customization. However, for example, a user presented with a plurality of existing language models previously customized by other users may not be capable of determining which language model among the presented language models contributes toward improving accuracy of recognition of the user's speech. In addition, when there are a large number of users using the same app, the users are conceivably presented with a large number of language models. If so, there may be cases where a user finds it difficult to suitably select a language model.

An object of the present disclosure is to provide a technique for supporting provision of a processing result that is preferable to a user using a model generating using learning data.

A computer system according to a mode of the present disclosure includes: a model generation system configured to generate a model using learning data; and a model management system configured to record model generation data created in accordance with users who use a prediction process based on the model in association with the users, group the users according to a prescribed grouping condition, and supply the model generation system with learning data including model generation data created in accordance with users belonging to the group and cause the model generation system to generate an integrated model corresponding to the group.

According to a mode of the present disclosure, provision of a processing result that is preferable to a user using a model to be generated using learning data can be supported.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram showing an embodiment of a machine learning system;

FIG. 2 is a diagram showing a configuration example of elements shared by a model management computer, an app management computer, an app execution computer, a model generation computer, and an evaluation execution computer shown in FIG. 1;

FIG. 3 is a diagram showing a configuration example of a model management table shown in FIG. 1;

FIG. 4 is a diagram showing a configuration example of a user information table shown in FIG. 1;

FIG. 5 is a diagram showing a configuration example of an app information table shown in FIG. 1;

FIG. 6 is a diagram showing a configuration example of a model information table shown in FIG. 1;

FIG. 7 is a diagram showing a configuration example of a learning data table shown in FIG. 1;

FIG. 8 is a diagram showing a configuration example of a group information table shown in FIG. 1;

FIG. 9 is a diagram showing a configuration example of a grouping condition table shown in FIG. 1;

FIG. 10 is a diagram showing a configuration example of an integration condition table shown in FIG. 1;

FIG. 11 is a diagram showing a configuration example of a model adoption condition table shown in FIG. 1;

FIG. 12 is a diagram showing a configuration example of an evaluation result table shown in FIG. 1;

FIG. 13 is a flow chart for illustrating processes executed by a model management program included in the model management computer shown in FIG. 1;

FIG. 14 is a flow chart for illustrating processes executed by a model generation program included in the model generation computer shown in FIG. 1;

FIG. 15 is a flow chart for illustrating processes executed by an evaluation execution program included in the evaluation execution computer shown in FIG. 1;

FIG. 16 is a flow chart for illustrating processes executed by a group management program included in the model management computer shown in FIG. 1;

FIG. 17 is a flow chart for illustrating processes executed by a notification management program included in the model management computer shown in FIG. 1;

FIG. 18 is a flow chart for illustrating processes executed by a model integration program included in the model management computer shown in FIG. 1; and

FIG. 19 is a diagram showing a screen example on which the notification management program shown in FIG. 1 displays a notification of model generation on an app of an app user.

### DETAILED DESCRIPTION OF THE EMBODIMENT

Hereinafter, a present embodiment will be described with reference to the drawings. While an app for supporting creation of minutes by subjecting speech data of a meeting to speech recognition and a custom model management system which improves a model used by an app user will be described in the present embodiment, it should be noted that the present mode is simply an example for explaining the present disclosure and is not intended to limit other configurations or modes capable of similar processes.

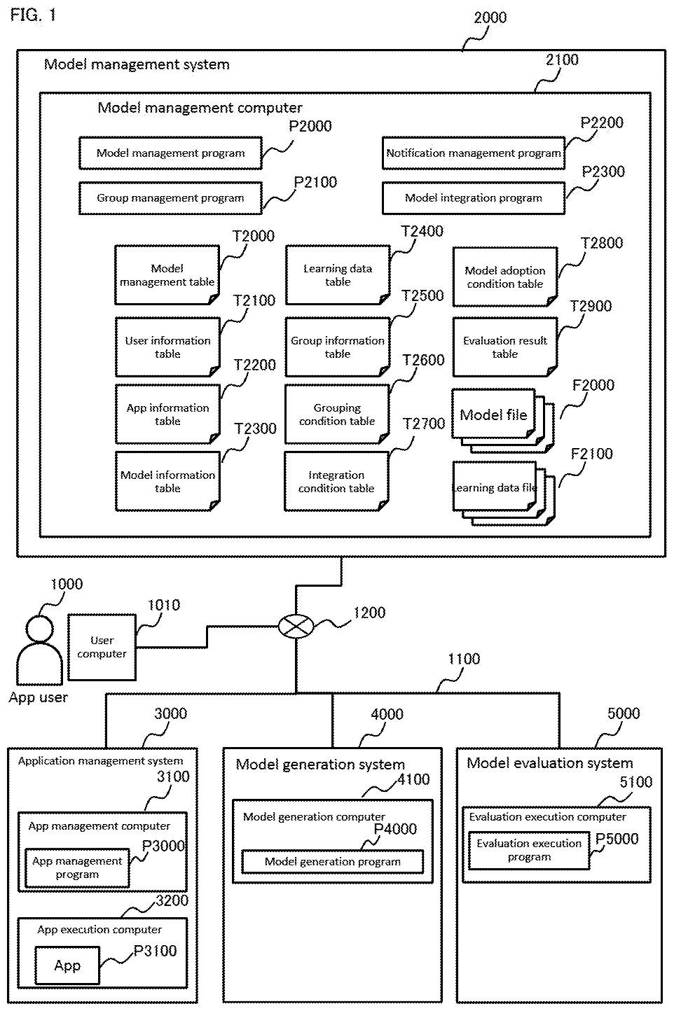

FIG. 1 is a diagram showing a machine learning system according to the present embodiment.

As shown in FIG. 1, the present embodiment includes a model management system 2000, an application management system 3000, a model generation system 4000, and a model evaluation system 5000.

Using one or more user computers 1010, an app user 1000 uses one or more apps P3100 to be executed on an app execution computer 3200. The user computer 1010 communicates with other systems via one or more networks 1100 and a network device 1200.

The model management system 2000 includes one or more model management computers 2100 and is responsible for managing models and accepting requests from the app user 1000. Specifically, the model management system 2000 records model generation data created in accordance with app users 1000 who use a prediction process based on a model in association with the app users 1000, group the app users 1000 according to a prescribed grouping condition, and supply the model generation system 4000 with learning data including model generation data created in accordance with the app users 1000 belonging to the group and cause the model generation system 4000 to generate an integrated model corresponding to the group. There may be one model management system 2000 or a plurality of model management systems 2000.

The model management computer 2100 includes: a model management program P2000 which provides means of model management; a group management program P2100 which provides means of managing a group of users; a notification management program P2200 which provides means of notification to the app users 1000; a model integration program P2300 which provides means of integrating models; a model management table T2000 which includes information on relationships among models, apps, users, and the like; a user information table T2100 which includes information on users; an app information table T2200 which includes information on apps; a model information table T2300 which includes information on models; a learning data table T2400 which includes information on learning data for model generation; a group information table T2500 which includes information on groups of users; a grouping condition table T2600 which includes information on conditions for constructing groups; an integration condition table T2700 which includes information on conditions for integrating custom models; a model adoption condition table T2800 which includes information on conditions for adopting a custom model to an app; an evaluation result table T2900 which includes information on results of model evaluation; a model file F2000 which represents an entity of a model; and a learning data file F2100 which represents an entity of learning data.

The application management system 3000 manages execution of apps used by a plurality of app users via a communication network which is constructed on the cloud and which is constituted by the network 1100 and the network device 1200, and includes one or more app management computers 3100 and one or more app execution computers 3200. There may be one application management system 3000 or a plurality of application management systems 3000. The configuration described above enables an application to provide users with services on the cloud and, accordingly, since collection of model generation data and update of models to be used for a prediction process can be readily performed and shared, prediction accuracy can be improved. In addition, the application management system 3000 executes an application that provides a user with a service including a prediction process based on at least one of a model and an integrated model generated by the model generation system 4000. As will be described later, a model and an integrated model generated by the model generation system 4000 are conceivably predictive models for a speech recognition process.

The app management computer 3100 includes one or more app management programs P3000. The app execution computer 3200 includes one or more apps P3100. The app management program P3000 includes means of managing operating information, performance information, and log information of the app P3100, information on a model being used, and data input to the app, and communicates with other systems via the network 1100 and the network device 1200. The app user 1000 communicates with and uses the app P3100 via the network 1100 and the network device 1200 from the user computer 1010. The app P3100 communicates with other systems via the network 1100 and the network device 1200.

The model generation system 4000 executes machine learning using learning data and generates a model to be used by an app, and includes one or more model generation computers 4100. Machine learning refers to the analysis of learning data and extraction of features. Machine learning can be used to generate a model for executing a prescribed process. In the present embodiment, the prescribed process is speech recognition. There may be one model generation system 4000 or a plurality of model generation systems 4000.

The model generation computer 4100 includes one or more model generation programs P4000. The model generation program P4000 communicates with other systems via the network 1100 and the network device 1200.

The model evaluation system 5000 performs an evaluation of a model using model evaluation data and includes one or more evaluation execution computers 5100. An example of model evaluation data is speech data for which a text representing a correct sentence, a correct word, or the like is known in advance. An evaluation result is a degree of match between a text that is obtained as a result of speech recognition with respect to the speech data and a text representing correct speech. There may be one model evaluation system 5000 or a plurality of model evaluation systems 5000. The evaluation execution computer 5100 includes an evaluation execution program P5000 and executes an evaluation process of a model. The evaluation execution computer 5100 communicates with other systems via the network 1100 and the network device 1200.

The model management computer 2100, the app management computer 3100, the app execution computer 3200, the model generation computer 4100, and the evaluation execution computer 5100 described above are connected to each other via one or more networks 1100 and one or more network devices 1200. While an example of the network 1100 is the Internet, the network 1100 may instead be a Virtual Private Network (VPN) or another network.

It should be noted that physical devices other than those described in the present application, wiring that connect the devices to each other, and the like may be present.

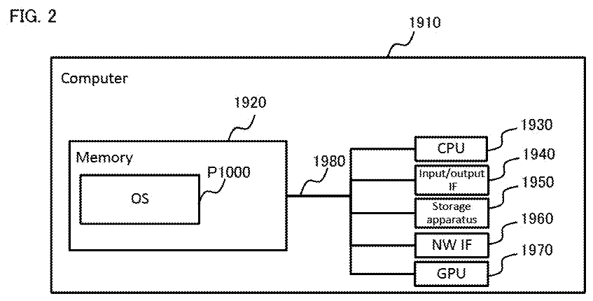

FIG. 2 is a diagram showing a configuration example of elements shared by the model management computer 2100, the app management computer 3100, the app execution computer 3200, the model generation computer 4100, and the evaluation execution computer 5100 shown in FIG. 1.

As shown in FIG. 2, a computer 1910 of the model management computer 2100, the app management computer 3100, the app execution computer 3200, the model generation computer 4100, and the evaluation execution computer 5100 shown in FIG. 1 includes a memory 1920, a CPU 1930, an input/output IF 1940, a storage apparatus 1950, a NW IF 1960, and a GPU 1970, which are connected by an internal bus 1980.

Programs are stored in the storage apparatus 1950 to be loaded to the memory 1920 and executed by the CPU 1930. It should be noted that an Operating System (OS) P1000 is loaded to a memory of all of the computers 1910 included in the system according to the present application to be executed by the CPU 1930.

All of the computers described above may be physical computers or virtual computers that run on physical computers. In addition, a storage apparatus of each computer is not an essential element and, for example, an external storage apparatus may be used or a storage service that logically provides functions of a storage apparatus may be used.

While an example of the NW IF included in each computer is a Network Interface Card (NIC), the NW IF may be constituted by other elements.

In addition, although each computer may include an output apparatus such as a display and an input/output IF such as a keyboard or a mouse, an input IF is not an essential element when the computer is remotely managed via a network by means such as Secure Shell (SSH). It should also be noted that the GPU 1970 is not an essential element.

The programs and the tables included in each computer described above may be included in a storage apparatus included in each computer. In addition, all of these programs are to be executed by the CPU included in each computer.

It should be noted that all of the computers included in the system according to the present application may be executed by a plurality of different computers as described above or may be executed by one computer. In addition, in each program, all of the steps may be executed by one computer or each step may be executed by a different computer.

In addition, the computer 1910 may include components other than those described in the present application and wiring or the like that connect the components.

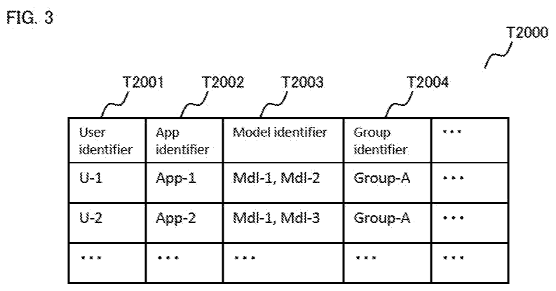

FIG. 3 is a diagram showing a configuration example of the model management table T2000 shown in FIG. 1.

The model management table T2000 includes information necessary for managing apps being used by users, a model being used by each app, and groups to which user and apps belong, and indicates which user is using which app and belongs to which group and, as shown in FIG. 3, includes a user identifier T2001, an app identifier T2002, a model identifier T2003, and a group identifier T2004.

The user identifier T2001 is information for uniquely identifying a user of an app and, for example, a serial number or an account name or an employer ID of the user may be used, or another value may be used as long as the value enables the user to be identified.

The app identifier T2002 is information for uniquely identifying an app being used by the user and, for example, a serial number or an app ID may be used, or another value may be used as long as the value enables the app to be identified.

The model identifier T2003 is information for uniquely identifying a model being used by an app and, for example, a model name or a model ID may be used, or another value may be used as long as the value enables the model to be identified. For example, it is shown that, in the case of a user with a user identifier of U-1, a model identified by Mdl-1 is used as a base model, a model identified by Mdl-2 is used as a custom model, and a combination of the models are applied.

The group identifier T2004 is information for uniquely identifying a group to which a user belongs and, for example, a group name or a group ID may be used, or another value may be used as long as the value enables the group to be identified.

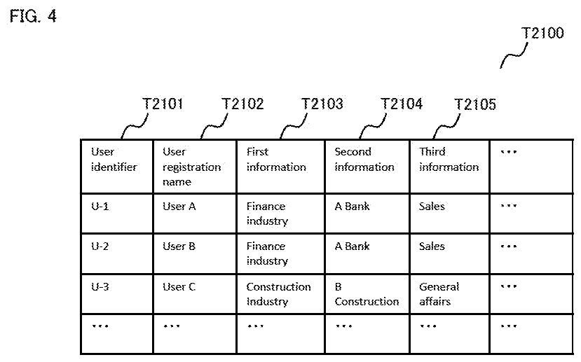

FIG. 4 is a diagram showing a configuration example of the user information table T2100 shown in FIG. 1.

The user information table T2100 includes information related to users using apps and, as shown in FIG. 4, includes a user identifier T2101, a user registration name T2102, first information T2103, second information T2104, and third information T2105.

The user identifier T2101 is information for uniquely identifying a user of an app and, for example, a serial number or an account name or an employer ID of the user may be used, or another value may be used as long as the value enables the user to be identified.

A user registration name T2102 is a name registered by the user in order to use an app and, for example, a name, an account name, or an account number may be used.

First information T2103 is a first piece of information which indicates an attribute of the user and, for example, information on a type of industry the user belongs to may be used.

Second information T2104 is a second piece of information which indicates an attribute of the user and, for example, information on a name of a corporation or an organization the user belongs to may be used.

Third information T2105 is a third piece of information which indicates an attribute of the user and, for example, information on a division or a section the user belongs to may be used.

The first information T2103, the second information T2104, and the third information T2105 described above indicate attributes including a division or a section of the user when the user belongs to an organization and may conceivably be acquired upon user registration from, for example, employee data.

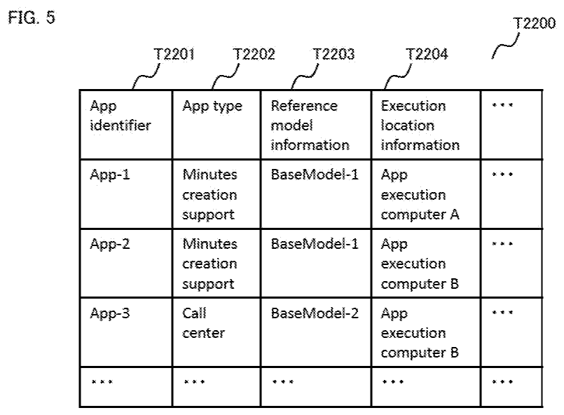

FIG. 5 is a diagram showing a configuration example of the app information table T2200 shown in FIG. 1.

The app information table T2200 includes information on apps used by a user and, as shown in FIG. 5, includes an app identifier T2201, an app type T2202, reference model information T2203, and execution location information T2204.

The app identifier T2201 is information used for uniquely identifying an app being used by the user and, for example, a serial number or an app ID may be used, or another value may be used as long as the value enables the app to be identified. The app identifier T2201 is generated at a timing where the user uses an app and, for this reason, the app identifier T2201 differs from one user to the next even in the case of same software.

The app type T2202 is information used for uniquely identifying a type of the app being used by the user and, for example, a character string representing an app name may be used.

The reference model information T2203 is information for uniquely identifying a model to be used by default when the app is deployed in an execution environment and a model name or a model ID may be used, or another value may be used as long as the value enables the model to be identified.

The execution location information T2204 is information for uniquely identifying a calculation environment in which the app is to be executed and, for example, a host name or an IP address of a computer or a virtual machine name may be used, or another value may be used as long as the value enables the calculation environment to be identified.

Since the app identifier T2201 is to be configured for each user, these pieces of information exist in the same number as there are users using apps and, by referring to the information, one can recognize which app is being used by each user.

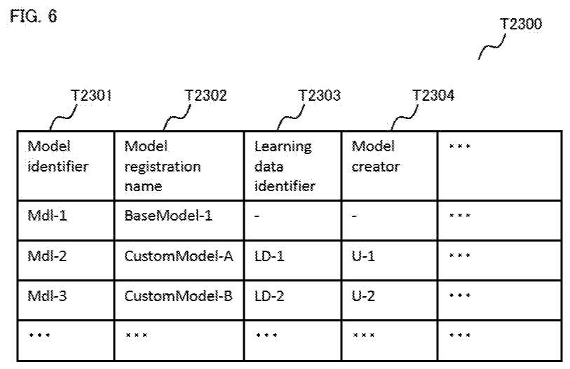

FIG. 6 is a diagram showing a configuration example of the model information table T2300 shown in FIG. 1.

The model information table T2300 includes information on models used by apps and, as shown in FIG. 6, includes a model identifier T2301, a model registration name T2302, a learning data identifier T2303, and a model creator T2304.

The model identifier T2301 is information for uniquely identifying a model being used by an app and, for example, a model name or a model ID may be used, or another value may be used as long as the value enables the model to be identified.

The model registration name T2302 is information for identifying a name of the model and is given by the app user 1000 who is a model creator or the model generation program P4000.

The learning data identifier T2303 is information for identifying data used by the app user to generate a model and, for example, a serial number or a data ID may be used, or another value may be used as long as the value enables the learning data to be identified. In addition, when the model is generated by someone other than the app user such as an app developer or a model developer, a value such as “-” which enables the model to be identified as a model generated by someone other than the app user may be used as the learning data identifier T2303, or another value may be used as long as the value enables the model to be identified as a model generated by someone other than the app user.

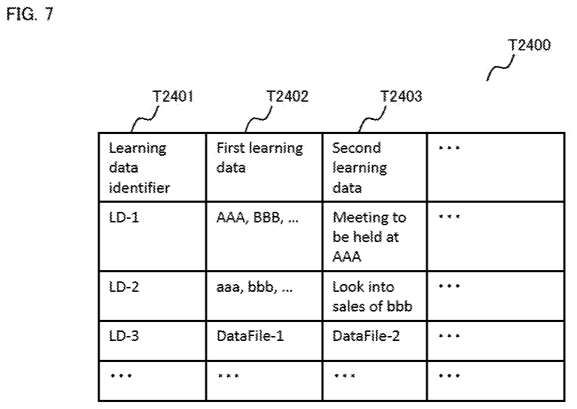

The model creator T2304 is information for uniquely identifying an app user having generated the model, and a value of the user identifier T2001 can be used. In addition, when the model is generated by someone other than the app user such as an app developer or a model developer, a value such as “-” which enables someone other than the app user to be identified as the model creator may be used as the model creator T2304, or another value may be used as long as the value enables someone other than the app user to be identified as the model creator. FIG. 7 is a diagram showing a configuration example of the learning data table T2400 shown in FIG. 1.

The learning data table T2400 includes information indicating what kind of data had been used when an app user generated a model and, as shown in FIG. 7, includes a learning data identifier 12401, first learning data T2402, and second learning data T2403.

The learning data identifier T2401 is information for identifying data used to generate a model and, for example, a serial number or a data ID may be used, or another value may be used as long as the value enables the learning data to be identified.

The first learning data T2402 represents data used to generate the model and, for example, a list of words such as proper nouns added in order to improve accuracy of speech recognition, a name of a file describing a word list, or information on a database storing data may be used, or another value may be used as long as the value enables the data used to generate the model to be identified.

The second learning data T2403 represents data used to generate the model and, for example, a list of example sentences added in order to improve accuracy of speech recognition, a name of a file describing an example sentence list, or information on a database storing data may be used, or another value may be used as long as the value enables the data used to generate the model to be identified.

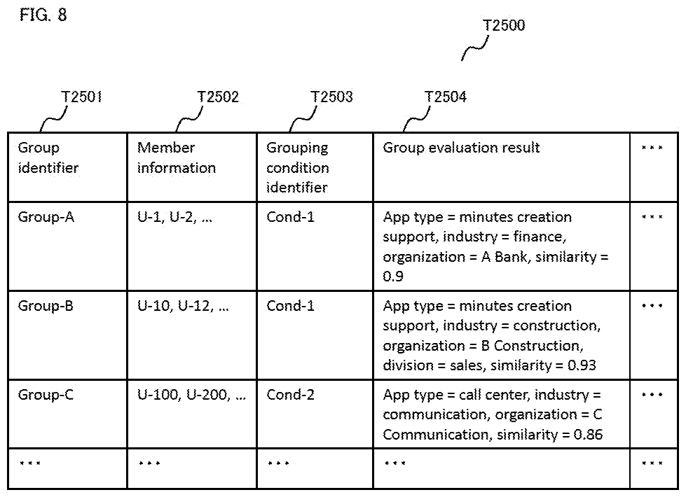

FIG. 8 is a diagram showing a configuration example of the group information table T2500 shown in FIG. 1.

The group information table T2500 includes information on groups to which app users belong, information on a grouping condition used to create groups to be units for organizing learning data, and information on a result of evaluations performed in accordance with the grouping condition and, as shown in FIG. 8, includes a group identifier T2501, member information T2502, a grouping condition identifier T2503, and a group evaluation result T2504.

The group identifier T2501 is information for uniquely identifying a group to which a user belongs and, for example, a group name or a group ID may be used, or another value may be used as long as the value enables the group to be identified.

The member information T2502 represents a set of app users belonging to the group and the user identifier T2101 in the user information table T2100 may be used, or another value may be used as long as the value enables the user to be identified.

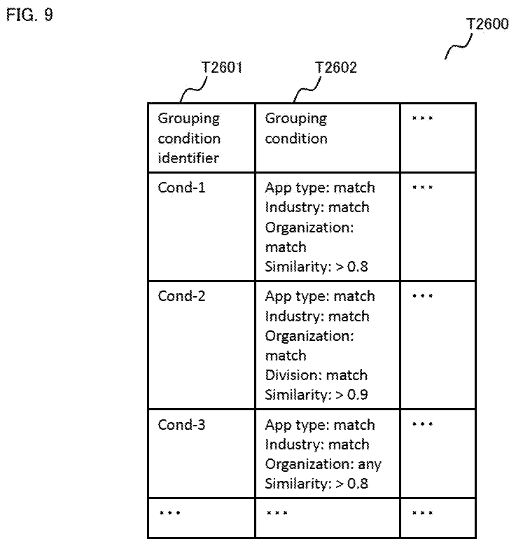

The grouping condition identifier T2503 represents information on a condition for selecting users belonging to the group and a value of the grouping condition identifier T2601 (refer to FIG. 9) in the grouping condition table T2600 may be used, or another value may be used as long as the value enables the grouping condition to be identified.

The group evaluation result T2504 represents a result of evaluating the grouping condition identifier T2503 of the group and may be represented by a character string such as “app type=minutes creation support, industry=finance, organization=A Bank, similarity=0.9”. It should be noted that when the app type is, for example, minutes creation support, the similarity is a similarity of text data of minutes, and when the app type is a call center, the similarity is a similarity of contents of an utterance by an operator.

FIG. 9 is a diagram showing a configuration example of the grouping condition table T2600 shown in FIG. 1.

The grouping condition table T2600 includes information on a condition to be satisfied when creating a group of users and, as shown in FIG. 9, includes a grouping condition identifier T2601 and a grouping condition T2602.

The grouping condition identifier T2601 is information for identifying a grouping condition and, for example, a value such as an arbitrary character string or a serial number may be used.

The grouping condition T2602 represents information on a condition to be satisfied when creating a group having a plurality of app users and, for example, the grouping condition may be defined by a character string such as “app type: match, industry: match, organization: match, similarity: >0.8” which indicates that the app is a match, the industry and the organization to which the user belongs are a match, and a similarity of a text output from a speech recognition process exceeds 0.8.

In this manner, since grouping is performed based on the user and the app type, similar model generation data can be shared among users. In addition, in doing so, by performing grouping based on a condition according to a similarity of a text included in output history of a speech recognition process, suitable grouping can be performed.

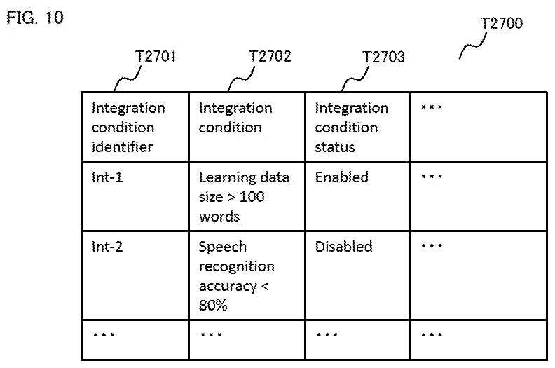

FIG. 10 is a diagram showing a configuration example of the integration condition table T2700 shown in FIG. 1.

The integration condition table T2700 includes information on a condition for determining whether or not models generated by users belonging to a same group are to be integrated and, as shown in FIG. 10, the integration condition table T2700 includes an integration condition identifier T2701, an integration condition T2702, and an integration condition status T2703.

The integration condition identifier T2701 is information for identifying an integration condition and, for example, a value such as an arbitrary character string or a serial number may be used.

The integration condition T2702 is information on a condition for determining whether or not models generated by users belonging to a same group are to be integrated and, for example, the integration condition T2702 may be represented by a character string such as “learning data size >100 words” which indicates that, as a data amount condition, a total amount of model generation data of users belonging to the group has exceeded 100 words or a character string such as “speech recognition accuracy <80%” which indicates that, as an accuracy condition, an accuracy of processing by an applied model has dropped to below 80%. In this manner, since an increase in an amount of customization data to be learned is used as a trigger for integrated model generation, generation of an integrated model can be executed at an appropriate time. In addition, using a decline in accuracy of a prediction process as a trigger for integrated model generation enables generation of an integrated model to be executed at an appropriate time.

The integration condition status T2703 is information representing whether or not the integration condition can be used and, for example, a character string such as “enabled” or “disabled” may be used or a number or a symbol may be used. The integration condition status T2703 can be turned on or off by the user.

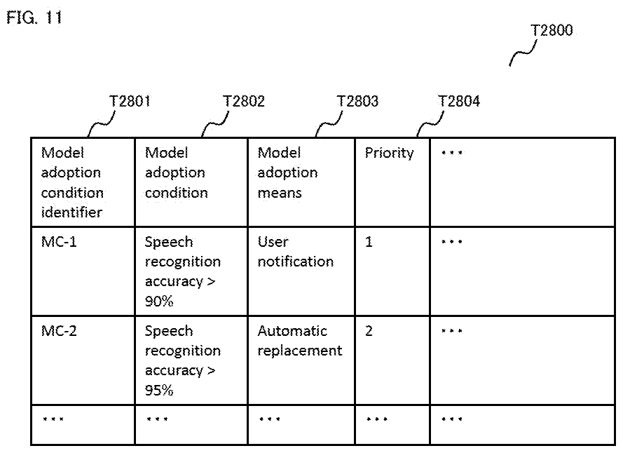

FIG. 11 is a diagram showing a configuration example of the model adoption condition table T2800 shown in FIG. 1.

The model adoption condition table T2800 includes information on a condition for adopting an integrated model and, as shown in FIG. 11, includes a model adoption condition identifier T2801, a model adoption condition T2802, model adoption means T2803, and a priority T2804.

The model adoption condition identifier T2801 is information for identifying a model adoption condition and, for example, a value such as an arbitrary character string or a serial number may be used.

The model adoption condition T2802 is information representing a condition for adopting a generated model to an app and, for example, the model adoption condition T2802 may be represented by a character string such as “speech recognition accuracy >90%”.

The model adoption means T2803 is information representing means of adopting a model satisfying the model adoption condition described above to an app and, for example, means of notifying a user of model information and adoption confirmation information after model generation to have the user determine whether or not to adopt the model may be represented as “user notification” or means of automatically replacing the model of the app with a new model when the model adoption condition is satisfied may be represented as “automatic replacement”.

The priority T2804 is information representing an order in which the model adoption condition is to be evaluated and may be represented by, for example, a number of a character string. In addition, when the model adoption condition is to be always evaluated, for example, a value such as “0” or “used always” may be used. Furthermore, in order to temporarily exclude a model from being evaluated, a value such as “−1” or “disabled” may be used. In the priorities shown in FIG. 11, the larger the number, the higher the priority. Therefore, for example, while a case where speech recognition accuracy is 97% falls under both model adoption condition identifiers MC-1 and MC-2, an adoption condition of the model adoption condition identifier MC-2 is applied and automatic replacement is to be performed.

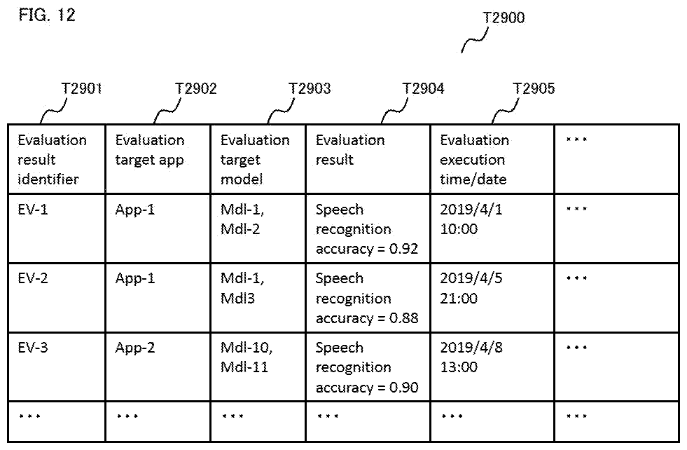

FIG. 12 is a diagram showing a configuration example of the evaluation result table T2900 shown in FIG. 1.

The evaluation result table T2900 includes information on an evaluation result of a model having been evaluated by the model evaluation system 5000 and includes an evaluation result identifier T2901, an evaluation target app T2902, an evaluation target model T2903, an evaluation result T2904, and an evaluation execution time/date T2905.

The evaluation result identifier T2901 is an identifier for uniquely identifying evaluation result information and, for example, a value such as a serial number is assigned by the evaluation execution program P5000.

The evaluation target app T2902 is information used for uniquely identifying an app that is the evaluation target and the app identifier T2201 of the app information table T2200 may be used or another value may be used as long as the value enables the app that is the evaluation target to be identified.

The evaluation target model T2903 is information used for uniquely identifying a model that is the evaluation target and the model identifier T2301 of the model information table T2300 may be used or another value may be used as long as the value enables the model that is the evaluation target to be identified.

The evaluation result T2904 is information representing an evaluation result of the model that is the evaluation target and is a value obtained when the evaluation execution program P5000 itself executes a speech recognition process of evaluation data using the evaluation target model and evaluates accuracy of a speech recognition result or when the evaluation execution program P5000 acquires log information of a result of speech recognition executed by an app managed by the app management program P3000 and evaluates accuracy of the speech recognition result, and the evaluation result T2904 may be represented by a numerical value, a symbol, or a character string such as “speech recognition accuracy=0.92”.

The evaluation execution time/date T2905 is information representing a time and date at which the evaluation execution program P5000 had been executed and may be represented by a character string such as “2019/4/1 10:00”.

Hereinafter, processes in the machine learning system configured as described above will be described.

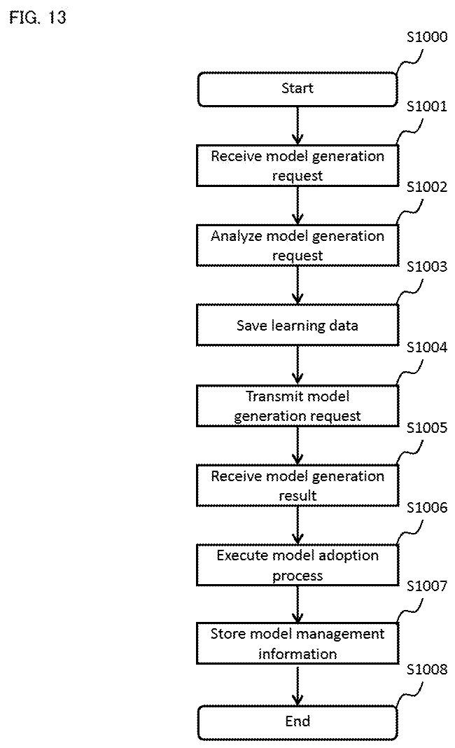

FIG. 13 is a flow chart for illustrating processes to be executed by the model management program P2000 included in the model management computer 2100 shown in FIG. 1, and shows processes in which the model management program P2000 receives a model generation request from the app user 1000 having been transmitted via the user computer 1010 and executes a process in response to the request.

When the model management program P2000 is executed, the model management program. P2000 starts to standby for a model generation request from the app user 1000 using a speech recognition process that is a prediction process based on a model (step S1000).

When the model management program P2000 receives the model generation request from the app user 1000 (step S1001), the model management program P2000 first analyzes the model generation request (step S1002). Since the model generation request from the app user 1000 includes, for example, identification information of the app user 1000, information on the app being used by the app user 1000, and learning data to be used for model generation, the model management program P2000 analyzes the information included in the received model generation request such as the identification information of the app user 1000, the information on the app being used by the app user 1000, and the learning data to be used for model generation.

Next, the model management program P2000 analyzes the learning data included in the model generation request and extracts first learning data T2402 and second learning data T2403, assigns a learning data identifier T2401, and adds the learning data to the learning data table T2400 as a new record (step S1003). The learning data may be stored in a file system or a storage service and a file path or an access address thereof may be described in the first learning data T2402 and the second learning data T2403.

Next, using the information included in the model generation request and the learning data registered in the learning data table T2400, the model management program P2000 transmits a model generation request to the model generation program P4000 (step S1004). For example, the model generation request includes identification information of the app user 1000, identification information of the app being used by the app user 1000, and the learning data identifier T2401.

Subsequently, when the model management program P2000 receives a model generation result from the model generation program P4000 (step S1005), the model management program P2000 executes a model adoption process using the received model generation result and the model adoption condition T2802 and the priority T2804 in the model adoption condition table T2800 (step S1006). It should be noted that the model generation result that is received by the model management program P2000 from the model generation program P4000 includes, for example, identification information of the app user 1000, identification information of the app being used by the app user 1000, identification information of the generated model, and evaluation information of the generated model. In the model adoption process, only the model adoption condition of which the priority T2804 is highest may be executed or model adoption conditions may be evaluated in a descending order of the priority T2804 and model adoption conditions satisfying a condition may be executed.

Next, based on the identification information of the app user and app information included in the model generation request received from the app user 1000 and identification information of the generated model which is included in the model generation result received in step S1005, the model management program P2000 stores model management information in the model management table T2000 (step S1007) and ends the process (step S1008). In doing so, when there is already a record having the same values of the user identifier and the app identifier concerned among the records of the model management table T2000, the information of the record is updated, but when there is no record having the same values of the user identifier and the app identifier concerned, a new record is created and information thereof is stored.

In this manner, model generation data that is generated by the model generation system 4000 in accordance with a user using a speech recognition process based on a model is to be recorded in association with the user.

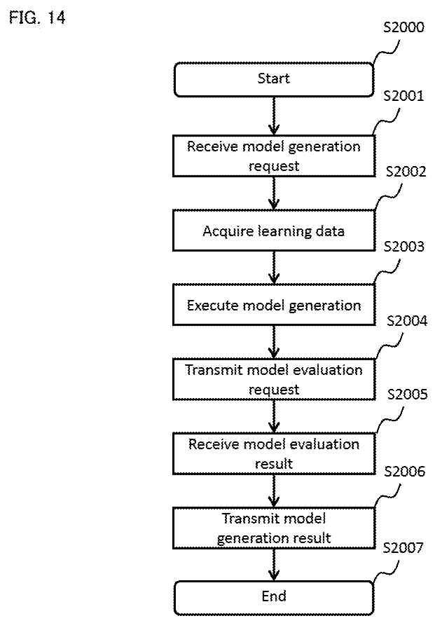

FIG. 14 is a flow chart for illustrating processes to be executed by the model generation program P4000 included in the model generation computer 4100 shown in FIG. 1, and shows processes in response to a model generation request transmitted from the model management program P2000 in step S1004 shown in FIG. 13.

When the model generation program P4000 is executed, the model generation program P4000 starts to standby for the model generation request transmitted from the model management program P2000 in step S1004 shown in FIG. 13 (step S2000).

When the model generation program P4000 receives the model generation request transmitted from the model management program P2000 (step S2001), the model generation program P4000 first acquires learning data indicated by the learning data identifier T2401 included in the received model generation request (step S2002). Since the model generation request received in step S2001 includes, for example, identification information of the app user 1000, identification information of the app being used by the app user 1000, and the learning data identifier T2401, the model generation program P4000 can acquire the learning data indicated by the learning data identifier 12401 included in the received model generation request.

Next, using the identification information of the app user 1000 and the identification information of the app being used by the app user 1000 which are included in the model generation request received in step S2001, the model generation program P4000 refers to the model management table T2000 and identifies the model identifier T2003 of a model being used. In addition, the model generation program P4000 executes machine learning using the learning data acquired in step S2002 and the model identified by the model identifier T2003 and generates a new model (hereinafter, referred to as a custom model) (step S2003).

Next, the model generation program P4000 transmits an evaluation request of a custom model to the evaluation execution program P5000 (step S2004). For example, the evaluation request includes identification information of an app, the custom model generated in step S2003, the learning data acquired in step S2002, and log information and app input data information managed by the app management program P3000.

Subsequently, when the model generation program P4000 receives an evaluation result with respect to the evaluation request from the evaluation execution program P5000 (step S2005), the model generation program P4000 transmits the model generation result of the model generated in step S2003 to a model generation request source (step S2006) and ends the process (step S2007). It should be noted that the evaluation result received from the evaluation execution program P5000 may be the evaluation result identifier T2901 in the evaluation result table T2900 or may include a part of or all of a record concerned of the evaluation result table T2900. In addition, the model generation request to be transmitted to the model generation request source includes, for example, the identification information of the app user 1000, the identification information of the app being used by the app user 1000, the identification information of the generated model, evaluation information of the generated model, and the evaluation result identifier T2901.

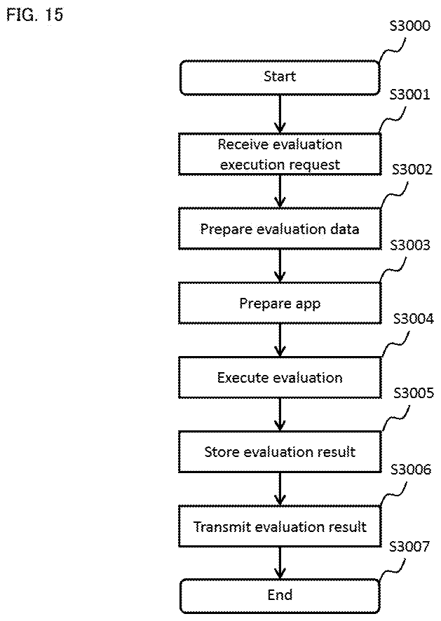

FIG. 15 is a flow chart for illustrating processes to be executed by the evaluation execution program P5000 included in the evaluation execution computer 5100 shown in FIG. 1 and shows processes in response to a model evaluation request transmitted from the model generation program P4000 in step S2004 shown in FIG. 14.

When the evaluation execution program P5000 is executed, the evaluation execution program P5000 starts to standby for the model evaluation request transmitted from the model generation program P4000 in step S2004 shown in FIG. 14 (step S3000).

When the evaluation execution program P5000 receives the model evaluation request transmitted from the model generation program P4000 (step S3001), the evaluation execution program P5000 first extracts app input data included in the model evaluation request and retains the extracted data as evaluation data (step S3002). For example, in the case of a minutes creation support app, the app input data may be meeting speech data or the like which had been input when previously using the app. It should be noted that the model evaluation request received in step S3001 includes app identification information, the custom model generated by the model generation program P4000 in step S2003, the learning data acquired by the model generation program P4000 in step S2002, and log information and app input data information managed by the app management program P3000.

Next, using the app identification information included in the model evaluation request, the evaluation execution program P5000 runs a same app as an evaluation app on the evaluation execution computer 5100 (step S3003). For example, an execution program of the app may be copied, an image file of a virtual machine storing the app may be acquired and run as a virtual machine, or a container image file storing the app may be acquired and run as a container. In addition, there may be a plurality of evaluation apps to be run.

Next, the evaluation execution program P5000 supplies the evaluation app run in step S3003 with the evaluation data retained in step S3002 as input and executes an evaluation (step S3004). When evaluation apps are to be run in plurality, the evaluation may be executed in a distributed manner by dividing the evaluation data into a plurality of pieces and input to a plurality of evaluation apps in a distributed manner. Furthermore, information on a time and date at which execution of the evaluation had been started is temporarily stored in a memory to be used in a next step.

Next, the evaluation execution program P5000 acquires a result of the evaluation execution, generates an evaluation result identifier T2901 of the evaluation result table T2900 and adds a new record, and stores the identification information T2902 of the evaluation target app, the evaluation target model information T2903, the evaluation result T2904, and the evaluation execution time/date T2905 in the record (step S3005).

Subsequently, the evaluation execution program P5000 transmits the evaluation result to a request source of the model evaluation request received in step S3001 (step S3006), and ends the process (step S3007). For example, the evaluation result may be the evaluation result identifier T2901 in the evaluation result table T2900 or may include a part of or all of the record concerned of the evaluation result table T2900.

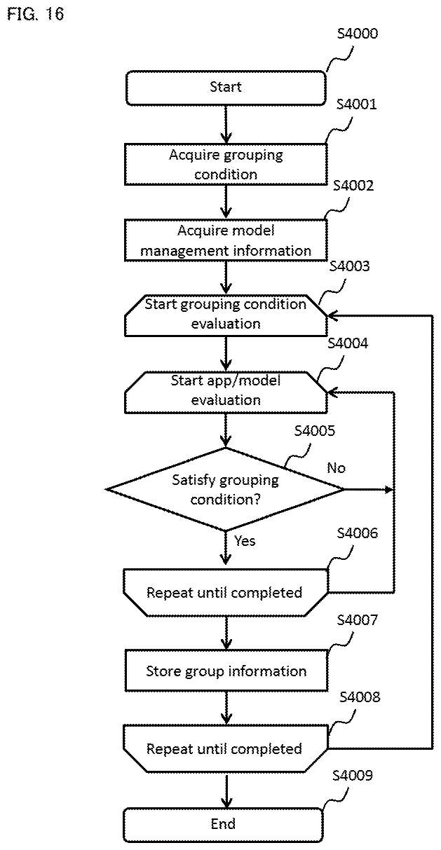

FIG. 16 is a flow chart for illustrating processes to be executed by the group management program P2100 included in the model management computer 2100 shown in FIG. 1 and shows processes for generating group information using information in the grouping condition table T2600 and the model management table T2000. The processes are performed at a timing that differs from the processes shown in FIGS. 13 to 15 such as a timing at which a user generates a custom model, a timing at which new users increase, or regularly.

When the group management program P2100 is executed (step S4000), the group management program P2100 first acquires all records of the grouping condition table T2600 (step S4001) and acquires all records of the model management table T2000 (step S4002).

Next, the group management program P2100 extracts one of the records of the grouping condition table T2600 acquired in step S4001 (step S4003) and acquires one of the records of the model management table T2000 acquired in step S4002 (step S4004).

Next, the group management program P2100 evaluates whether or not the model management information extracted in step S4004 satisfies the grouping condition extracted in step S4003 (step S4005). For example, in the grouping condition table T2600 shown in FIG. 9, first, a grouping condition “app type: match, industry: match, organization: match, similarity >0.8” with a grouping condition identifier of “fond-1” is an evaluation target.

Next, in the model management table T2000 shown in FIG. 3, a record of which the user identifier is “U-1” and the app identifier is “App-1” is the evaluation target. In this case, the information of the app user “U-1” is information of which the user identifier T2101 is “U-1” in the user information table T2100 shown in FIG. 4.

In addition, the information of the app identifier “App-1” is information of which the app identifier T2201 is “App-1” in the app information table T2200 shown in FIG. 5.

By referring to these pieces of information, the group management program P2100 acquires “app type: minutes creation support, industry: finance, organization: A Bank” based on the user identifier “U-1” and the app identifier “App-1”.

In addition, the group management program P2100 sequentially performs a same process with respect to each record presently not being evaluated and acquires information on “app type, industry, and organization”. For example, in the case of the user identifier “U-2” and the app identifier “App-2”, “app type: minutes creation support, industry: finance, organization: A Bank” is acquired.

Since the pair of the user identifier “U-1” and the app identifier “App-1” and the pair of the user identifier “U-2” and the app identifier “App-2” satisfy “app type: match, industry: match, organization: match” among the grouping condition, calculation of a similarity is next executed.

The similarity may be calculated by acquiring log information of each app from the app management program P3000 and analyzing rates of occurrence of keywords by morphological analysis, calculating a similarity between sentences using Word2Vec, or using a clustering analysis method.

When the calculated similarity satisfies a grouping condition “similarity: >0.8”, a user identifier having satisfied the grouping condition, a grouping condition identifier, and a group evaluation result are recorded on a memory managed by the group management program P2100.

In addition, when all of the records have been evaluated (step S4006), the group management program P2100 adds a new record to the group information table T2500, stores the value of the group identifier T2501, stores the user identifier evaluated as satisfying the grouping condition in step S4005 in the member information T2502, stores the grouping condition used for the evaluation in the grouping condition identifier T2503, and stores the evaluation result in the group evaluation result T2504 (step S4007).

Meanwhile, when the grouping condition is not satisfied in step S4005 or when there is a record for which the grouping condition has not yet been evaluated among the records of the model management table, a return is made to the process of step S4004.

In addition, once all of the records have been evaluated (step S4008), the process is ended (step S4009).

Meanwhile, when there is a record for which the grouping condition has not yet been evaluated among the records of the grouping condition table, a return is made to the process of step S4003.

In this manner, users using a speech recognition process are to be grouped according to a prescribed grouping condition by the group management program P2100.

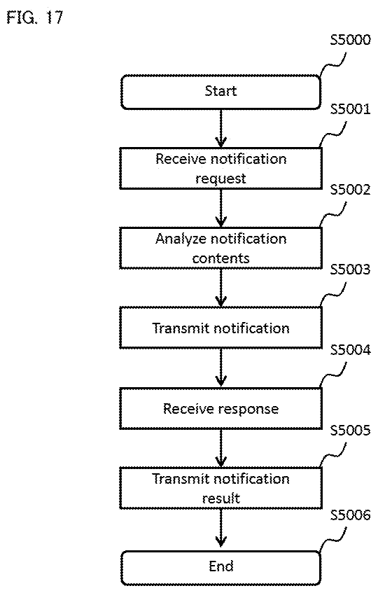

FIG. 17 is a flow chart for illustrating processes to be executed by the notification management program P2200 included in the model management computer 2100 shown in FIG. 1 and shows processes of receiving a notification request and performing a notification.

When the notification management program P2200 is executed, the notification management program P2200 starts to stand by for a notification request (step S5000).

When the notification management program P2200 receives a notification request (step s5001), the notification management program P2200 analyzes contents of the received notification request and executes identification of an app that is a notification destination, shaping of notification contents, identification of whether or not the notification requires a response, and the like (step S5002). It should be noted that the notification request includes, for example, identification information of the app user 1000, identification information of an app being used by the app user 1000, information on a model used by the app, evaluation information of the model, and whether or not a response is required, and the notification request may be transmitted by the model management program P2000 in step S1006 shown in FIG. 13 or may be transmitted by another program.

Next, the notification management program P2200 transmits the notification contents analyzed in step S5002 to the app being used by the app user 1000 (step S5003).

Subsequently, when the notification management program P2200 receives a response to the notification transmitted to the app in step S5003 (step S5004), the notification management program P2200 transmits the received response to the notification as a notification result to a request source of the notification request (step S5005), and ends the process (step S5006). It should be noted that the notification result includes, for example, value indicating a success or a failure of a notification process, information on the response received in step S5004, and the like. In addition, when it is not designated in the notification request that a response to the notification is necessary, the process advances to step S5005 without waiting to receive a response.

Examples of a case where a response to the notification is necessary include, but are not limited to, a case where the model management program P2000 notifies a user of whether a generated model is to be adopted or not and requires a response regarding whether the generated model is to be adopted.

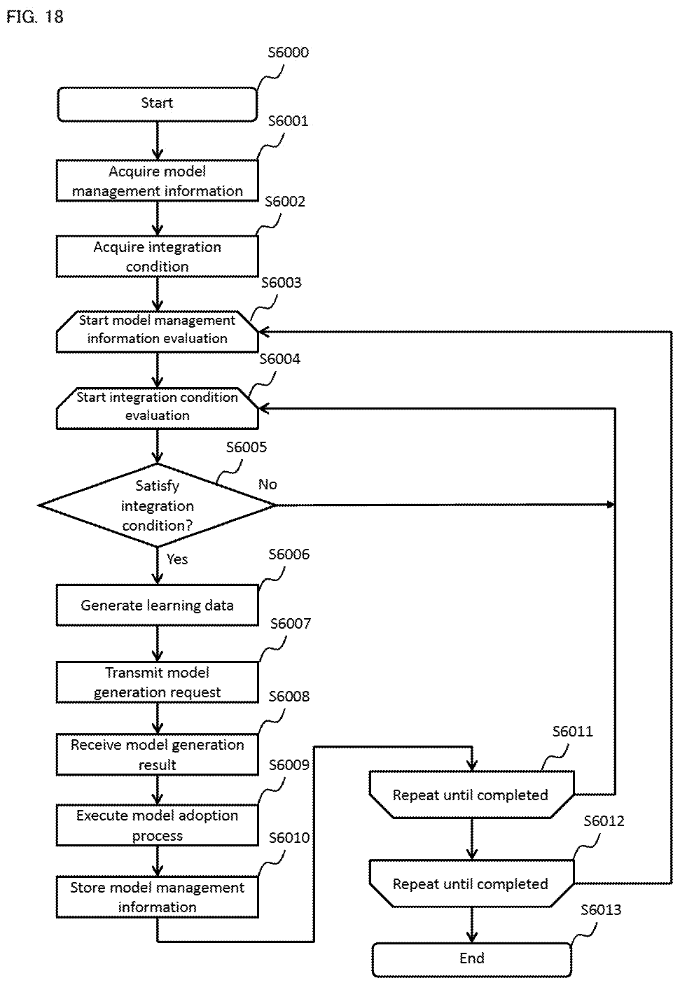

FIG. 18 is a flow chart for illustrating processes to be executed by the model integration program P2300 included in the model management computer 2100 shown in FIG. 1 and shows processes of integrating models in accordance with information in the integration condition table T2700. It should be noted that the model integration program P2300 may be periodically activated by the model management program P2000 or may be activated upon receiving a request for model integration from the app user 1000.

When the model integration program P2300 is executed (step S6000), the model integration program P2300 acquires all records of the model management table T2000 (step S6001) and acquires all records of the integration condition table T2700 (step S6002). However, when a value indicating non-use such as a character string reading “disabled” is stored in the integration condition status T2703, the record concerned is not acquired.

Next, the model integration program P2300 extracts one of the records of the model management table T2000 acquired in step S6001 (step S6003) and extracts one of the records of the integration condition table T2700 acquired in step S6002 (step S6004).

Next, the model integration program P2300 searches for model management information of which the group identifier 12004 included in the model management information is the same from the model management table T2000 acquired in step S6001, acquires information for evaluating the integration condition T2702 from the learning data table T2400, the evaluation result table T2900, and the app management program. P3000, and evaluates the integration condition (step S6005).

When the integration condition is satisfied, the model integration program P2300 refers to model information included in the group information satisfying the integration condition and acquires the learning data identifier 12303 associated with the model identifier T2301. When a value enabling a model to be identified as a model generated by someone other than an app user such as “-” is stored in the learning data identifier, the learning data identifier is not acquired. The model integration program P2300 acquires learning data indicated by all of the acquired learning data identifiers 12303 from the learning data table 12400 and integrates the learning data into a single piece of learning data (step S6006).

Meanwhile, when the integration condition is not satisfied, a return is made to the process of step S6004.

Using the integrated learning data, the model integration program P2300 transmits a model generation request to the model generation program P4000 (step S6007). In this manner, the model management system 2000 supplies the model generation system with learning data including model generation data created in accordance with users belonging to a group to generate an integrated model corresponding to the group.

Subsequently, when the model integration program P2300 receives a model generation result from the model generation program P4000 (step S6008), the model integration program P2300 executes a model adoption process using the received model generation result and the model adoption condition T2802 and the priority T2804 in the model adoption condition table T2800 (step S6009). In the model adoption process, only the model adoption condition of which the priority T2804 is highest may be executed or model adoption conditions may be evaluated in a descending order of the priority T2804 and model adoption conditions satisfying a condition may be executed. It should be noted that the model generation result that is received from the model generation program P4000 includes, for example, identification information of the app user 1000, identification information of the app being used by the app user 1000, identification information of the generated model, and evaluation information of the generated model. Since whether or not a generated integrated model is to be adopted is determined based on an evaluation result of the integrated model, an integrated model evaluated as having high reliability can be obtained. In addition, when the model adoption means T2803 is set to user notification, an integrated model can be applied based on a user's intention by presenting information based on an evaluation result to the user to prompt the user to determine whether or not the integrated model is to be adopted, and when the user makes a determination to adopt the integrated model, adopting the integrated model with respect to the user. Furthermore, by determining whether or not to adopt an integrated model in accordance with priorities assigned to a plurality of adoption conditions for determining whether or not to adopt the integrated model, an integrated model in accordance with the user can be applied while configuring a plurality of adoption conditions for determining whether or not to adopt the integrated model.

Next, based on the received model generation result, the model integration program P2300 stores model management information in the model management table T2000 (step S6010). When there is already a record having the same values of the user identifier and the app identifier concerned among the records of the model management table T2000, the information of the record is updated, but when there is no record having the same values of the user identifier and the app identifier concerned, a new record is created and information thereof is stored.

When all of the records in the integration condition table are evaluated (step S6011) and all of the records in the model management table are evaluated (step S6012), the model integration program P2300 ends the process (step S6013).

Meanwhile, when there is a record that is not yet evaluated among the records of the integration condition table, a return is made to the process of step S6004, and when there is a record that is not yet evaluated among the records of the model management table, a return is made to the process of step S6003.

As described above, in a case where a prescribed integration condition is satisfied when the model integration program P2300 executes grouping, by causing the model generation system 4000 to generate an integrated model corresponding to a group, an integrated model suitable for the group can be promptly applied.

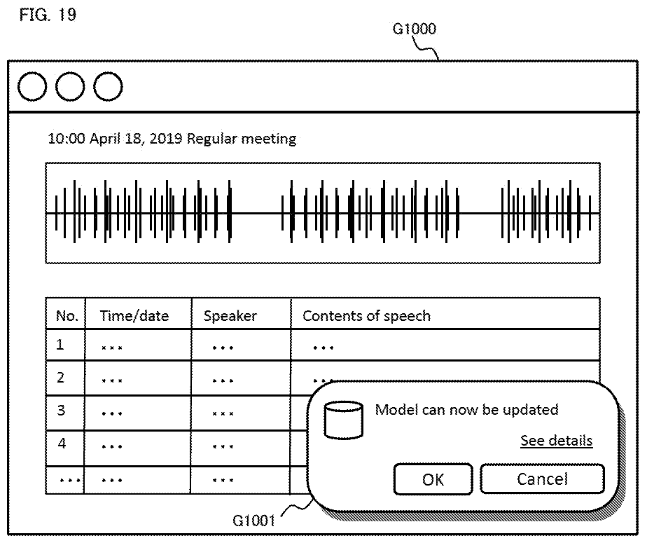

FIG. 19 is a diagram showing a screen example on which the notification management program P2200 shown in FIG. 1 displays a notification of model generation on the app P3100 of the app user 1000.

In the present screen example, as shown in FIG. 19, a screen G1000 in a case where the app P3100 is a minutes creation support app is shown.

Notification contents G1001 transmitted by the notification management program P2200 to the app P3100 is displayed on the screen G1000.

For example, an icon, a notification message, a link or a button for further displaying detailed information, and a plurality of buttons that enable the user 1000 to select an action in response to a notification may be displayed in the notification contents G1001. In addition to “OK” and “cancel”, the action may be set to “adopted” or “not adopted” in order to select whether or not to adopt a model.

As the notification contents G1001, besides being displayed in a banner format, a notification function included in the operating system of the user computer 1010 such as a notification function of a task tray may be used, and the notification contents G1001 may be displayed in a ribbon shape in an upper part of the screen G1000, the app P3100 may further transmit a notification to a terminal of the user 1000 such as a smartphone or a tablet and have the notification be displayed on the terminal, and other methods may be used as long the notification contents can be displayed.

When the user 1000 selects an action displayed in the notification contents G1001, information on the selected item is transmitted to the notification management program P2200. However, when the notification contents G1001 do not have buttons that enable the user 1000 to select an action, the transmission of the selected item to the notification management program P2200 is not performed.

As described above, in the present embodiment, since users are grouped and an integrated model corresponding to a group is generated by performing machine learning of model generation data created in accordance with users belonging to the group, an improvement in a processing result to be provided to the user by a prediction process using a model can be supported. Specifically, even when the app user 1000 is unaware of details of custom models of other users, the app user 1000 can use a model that is highly accurate with respect to a plurality of users belonging to a same domain and an improvement in a satisfaction level of app users is anticipated.

When an app utilizing speech recognition technology is provided on a common infrastructure such as cloud computing, a plurality of users may conceivably individually use the same app on the common infrastructure. In doing so, since an execution environment of the app is isolated for each user even though the infrastructure is shared, each user performs model customization in order to improve speech recognition accuracy of the user's own app.

Meanwhile, among a plurality of users using a same app, users who belong to a same industry or belong to divisions in similar lines of work in a same corporation often produce utterances with similar contents to be used as targets of speech recognition. For example, in the case of a minutes creation support app which applies speech recognition on speech data of a meeting, speech produced by users belonging to a same industry conceivably includes common industry jargon. In such a case, by adopting configurations and means according to the embodiment described above, models customized by other users can also be used and a greater improvement in accuracy of speech recognition can be expected as compared to a case where individual users perform customization on an individual basis.

While a speech recognition process has been described as an example of a prediction process in the embodiment described above, the prediction process is not limited to a speech recognition process and other examples such as image recognition are also conceivable.

Although the present disclosure has been described with reference to example embodiments, those skilled in the art will recognize that various changes and modifications may be made in form and detail without departing from the spirit and scope of the claimed subject matter.

What is claimed is:

1. A computer system, comprising:
a model generation system configured to generate a model using learning data; and
a model management system configured to record model generation data created in accordance with user who uses a prediction process based on the model in association with the user, group users according to a prescribed grouping condition, and supply the model generation system with learning data including model generation data created in accordance with users belonging to the group and cause the model generation system to generate an integrated model corresponding to the group.

2. The computer system according to claim 1, further comprising an application management system configured to execute an application for providing the user with a service including a prediction process based on at least one of the model and the integrated model, wherein
the grouping condition is defined based on a type of the application and an attribute of the user.

3. The computer system according to claim 2, wherein
the model and the integrated model are predictive models for a speech recognition process, and
the grouping condition is defined based on a type of the application, an attribute of the user, and a similarity of a text output from the speech recognition process.

4. The computer system according to claim 2, wherein
the application management system is a system which is constructed on the cloud and in which a plurality of users use an application via a communication network.

5. The computer system according to claim 1, wherein
the model management system is configured to cause, in a case where a prescribed integration condition is satisfied when the grouping is executed, the model generation system to generate an integrated model corresponding to the group.

6. The computer system according to claim 5, wherein
the integration condition includes a data amount condition that a total amount of model generation data of users belonging to a group exceeds a prescribed threshold.

7. The computer system according to claim 5, wherein
the integration condition includes an accuracy condition that accuracy of a process based on an applied model drops below a prescribed threshold.

8. The computer system according to claim 1, further comprising a model evaluation system configured to evaluate a model using model evaluation data, wherein
the model generation system is configured to, when generating the integrated model, cause the model evaluation system to evaluate the integrated model and provide the model management system with an evaluation result together with the integrated model, and
the model management system is configured to determine whether or not to adopt the integrated model based on the evaluation result.

9. The computer system according to claim 8, wherein
the model management system is configured to present information based on the evaluation result to the user and prompt the user to determine whether or not to adopt the integrated model, and when the user determines to adopt the integrated model, adopt the integrated model with respect to the user.

10. The computer system according to claim 8, wherein
the model management system includes a plurality of adoption conditions for determining whether or not to adopt the integrated model and is configured to determine whether or not to adopt the integrated model in accordance with priorities assigned to the plurality of adoption conditions.

11. A model generation method of generating an integrated model based on a model generated using learning data,
the model generation method causing a computer to:
record model generation data created in accordance with user who uses a prediction process based on the model in association with the user;
group users according to a prescribed grouping condition; and
generate an integrated model corresponding to the group using learning data including model generation data created in accordance with users belonging to the group.

12. A computer readable recording medium containing a model management program for causing a model generation system that generates a model using learning data to generate an integrated model,
the model management program causing a computer to:
record model generation data created in accordance with user who uses a prediction process based on the model in association with the user;
group users according to a prescribed grouping condition; and
supply the model generation system with learning data including model generation data created in accordance with users belonging to the group and cause the model generation system to generate an integrated model corresponding to the group.
